(19) United States
(12) Patent Application Publication
(10) Pub. No.: US 2022/0200306 A1
(43) Pub. Date: Jun. 23, 2022

(54) OVERCHARGE PROTECTION IN ELECTROCHEMICAL CELLS

(71) Applicant: 24M Technologies, Inc., Cambridge, MA (US)

(72) Inventors: Yuki KUSACHI, Burlington, MA (US); Naoki OTA, Lexington, MA (US); Junzheng CHEN, Concord, MA (US)

(21) Appl. No.: 17/687,242

(22) Filed: Mar. 4, 2022

Related U.S. Application Data
(63) Continuation of application No. PCT/US2020/049691, filed on Sep. 8, 2020.
(60) Provisional application No. 62/896,684, filed on Sep. 6, 2019.

(51) Int. Cl. H02J 7/00; H01M 50/581; H01M 10/0525

(52) U.S. Cl. CPC H02J 7/00302; H02J 7/00309; H01M 2200/10; H01M 10/0525; H01M 50/581

(57) ABSTRACT

Embodiments described herein relate to systems and methods of overcharge protection in electrochemical cells by utilizing properties inherent to battery materials. An overcharge inhibitor is disposed in at least one of an anode and a cathode and is configured to inhibit ion transfer when a triggering condition is met. In some embodiments, the triggering condition can be a voltage difference between the anode and the cathode. In some embodiments, the triggering condition can be a temperature in the anode and/or the cathode. In some embodiments, the overcharge inhibitor can include a compound disposed in the cathode and/or the anode configured to generate a gas when the triggering condition is met. In some embodiments, the overcharge inhibitor can include a plurality of particles disposed in the cathode and/or the anode configured to absorb a portion of a liquid electrolyte and expand when the triggering condition is met.

### RELATED APPLICATIONS

This application claims priority and benefit of U.S. Provisional Application No. 62/896,684, filed Sep. 6, 2019 and entitled “Overcharge Protection in Electrochemical Cells,” the entire disclosure of which is hereby incorporated by reference herein in its entirety.

### BACKGROUND

Charging a battery beyond its intended state of charge can cause a variety of problems, including but not limited to undesired gas generation, excess heat generation, fire hazards, and electrolyte vaporization. Overcharge protection methods currently employed often require external equipment, are costly to implement, and are not adaptable to all battery builds. For example, external equipment is difficult to implement in a pouch battery structure. An enduring challenge is to create a built-in safety mechanism for overcharge protection in an electrochemical cell. Such a cell or system of cells can allow a battery to charge safely without any significant compromise to the usable lifetime of the battery.

### SUMMARY

Embodiments described herein relate to systems and methods of overcharge protection in electrochemical cells by utilizing properties inherent to battery materials. Electrochemical cells include a cathode disposed on a cathode current collector, an anode disposed on an anode current collector, and a separator disposed between the anode and the cathode. An overcharge inhibitor is disposed in at least one of the anode and the cathode and is configured to inhibit ion transfer when a triggering condition is met. In some embodiments, the triggering condition can be a voltage difference between the anode and the cathode. In some embodiments, the triggering condition can be a temperature in the anode and/or the cathode. In some embodiments, the overcharge inhibitor can include a compound disposed in the cathode and/or the anode configured to generate a gas when the triggering condition is met. In some embodiments, the generated gas can inhibit electrical contact between the cathode and the cathode current collector. In some embodiments, the generated gas can inhibit electrical contact between the anode and the anode current collector. In some embodiments, the overcharge inhibitor can include a plurality of particles disposed in the cathode and/or the anode configured to absorb a portion of a liquid electrolyte and expand when the triggering condition is met. In some embodiments, the expanded particles can inhibit the flow of ions within the anode and/or cathode and can inhibit electrical contact between the electrode and the current collector. In some embodiments, the cathode and/or the anode can include a semi-solid electroactive material that includes a suspension of an active material and a conductive material in a liquid electrolyte.

### BRIEF DESCRIPTION OF THE DRAWINGS

FIG. 1 is a schematic illustration of an electrochemical cell including an external overcharge protection device.

FIGS. 2A-2B are schematic illustrations of an electrochemical cell including an additive configured to coat the electroactive species.

FIG. 3 is a schematic illustration of an electrochemical cell including an overcharge inhibitor, according to an embodiment.

FIG. 4 is a schematic illustration of an electrochemical cell including an overcharge inhibitor, according to an embodiment.

FIGS. 5A-5B are schematic illustrations of an electrochemical cell, according to an embodiment.

### DETAILED DESCRIPTION

Embodiments described herein relate generally to electrochemical cells having overcharge inhibitors, and more specifically to systems and methods of providing overcharge protection in electrochemical cells by utilizing properties inherent to battery materials. Electrochemical cells are susceptible to short circuit and overcharge conditions, which may lead to unwanted or unpredictable releases of energy and resulting thermal runaway. Overcharge protection is an important functionality in electrochemical cells, both in terms of safety and economy. Depending on battery chemistry and build type, overcharging can cause a wide range of problems. In a sealed battery, such as a lithium ion battery, excessive charging can lead to gas generation and ultimately rupture or explosion of the electrochemical cell. In a vented cell, overcharging can lead to gas generation and electrolyte vaporization. Excessive electrolyte vaporization can expose the electrode materials to the surrounding atmosphere, rendering them unusable. Heat generation from overcharging can also create an environment more conducive to ignition and fires. Irreversible side reactions can also occur when an electrochemical cell charges beyond its specified voltage, hampering the electrochemical cell's capacity with each successive cycle. This can reduce the usable lifetime of an electrochemical cell, thereby increasing the frequency of replacement costs.

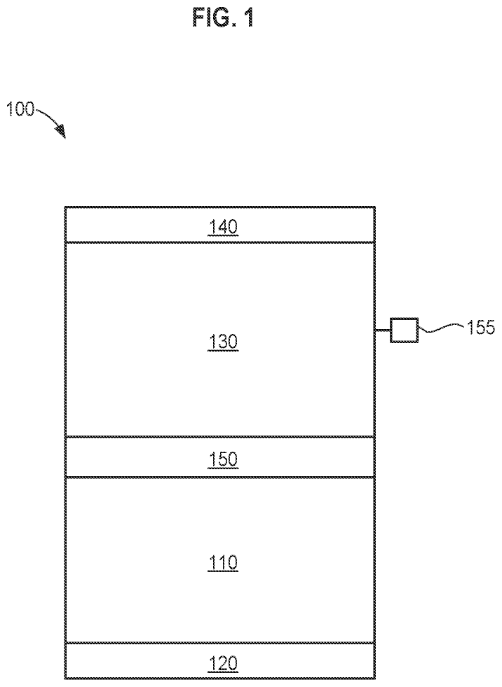

Several methods of overcharge protection are currently employed commercially. These methods often use an external overcharge inhibitor that adjusts the charge current based on the measured cell voltage. FIG. 1 shows a schematic view of an electrochemical cell 100 that can limit overcharging effects, as commonly used in the current state of the art. The electrochemical cell 100 includes an anode 110 disposed on an anode current collector 120, a cathode 130 disposed on a cathode current collector 140, and a separator 150 disposed between the anode 110 and the cathode 130. The electrochemical cell 100 further includes an overcharge inhibitor 155 connected to the cathode 130. As shown, the overcharge inhibitor 155 is an external overcharge inhibitor. The overcharge inhibitor 155 is often a current interruption device with wiring and/or electrical components connected to the cathode 130 as shown, or alternatively to the anode 110, or both the cathode 130 and the anode 110. The overcharge inhibitor 155 inhibits or substantially restricts the charging current of the electrochemical cell 100 at a prescribed voltage, temperature, and/or pressure in the electrochemical cell 100 via an arrangement of circuitry. In some cases, the reduction in current can be a gradual process, in which the charge current reduces slowly at a first voltage, lower than the maximum charging voltage, until it reaches zero current at the maximum charging voltage.

Overcharge inhibitors 155 implemented via external circuitry are difficult to implement when the electrochemical cell 100 is contained in a pouch (not shown). Adding wiring to a sealed pouch increases the potential for leaks. The overcharge inhibitor 155 can also increase the equipment cost. The assembly of wires and electrical circuitry devices that make up the overcharge inhibitor 155 can add up significantly if employed with a large number of electrochemical cells 100. These components are not only costly in the manufacture of electrochemical cells 100, but can increase the number of components that can malfunction or can be installed improperly. This leads to a relatively high percentage of defective electrochemical cells 100.

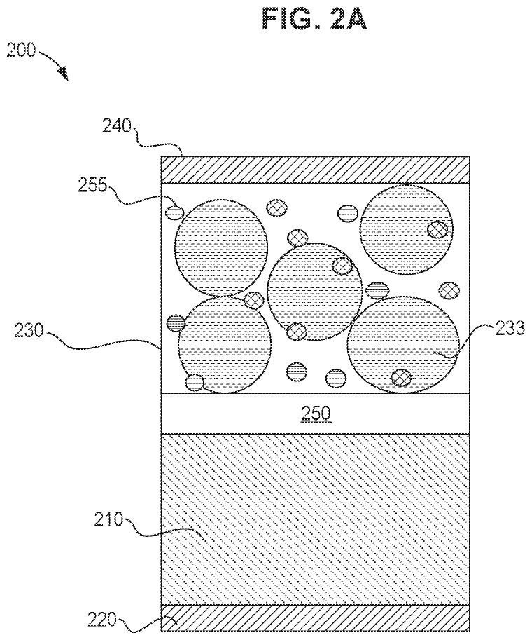

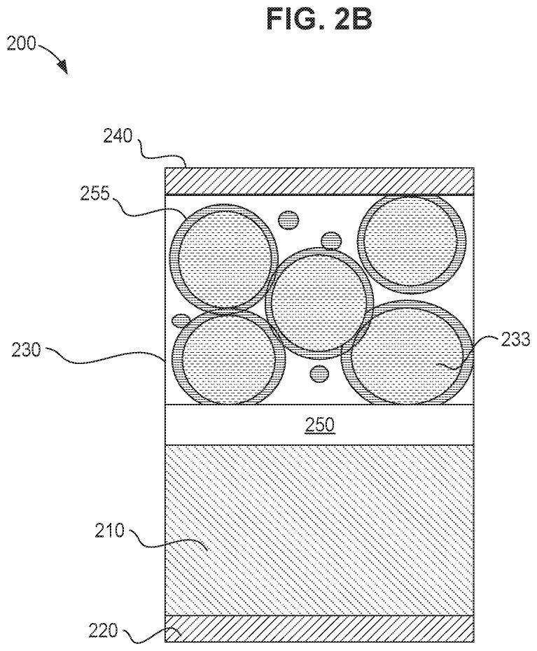

FIGS. 2A-2B show a schematic view of an electrochemical cell 200 that can limit overcharging effects, as commonly used in the current state of the art. The electrochemical cell 200 includes an anode 210 disposed on an anode current collector 220, a cathode 230 including cathode active material 233 disposed on a cathode current collector 240, and a separator 250 disposed between the anode 210 and the cathode 230. The electrochemical cell 200 further includes an overcharge inhibitor 255 disposed in the cathode 230. The overcharge inhibitor 255 is often in the form of binder particles as shown in FIG. 2A. As heat is generated in the electrochemical cell 200, the binder particles polymerize and agglomerate on the surface of the cathode active material 233. This agglomeration inhibits the flow of ions between particles of the cathode active material 233. This polymerization and agglomeration can similarly occur in the anode 210. While this approach can effectively limit the temperature increase due to overcharging, binder materials that can effectively polymerize and agglomerate are expensive. Additionally, reversal of the polymerization and agglomeration can be difficult and the effectiveness of the binder material can degrade throughout the lifetime of the electrochemical cell 200. Thus, a need exists for an inexpensive and effective overcharge protection mechanism that can be used in pouch cells and that does not contribute to the degradation of the electrochemical cell.

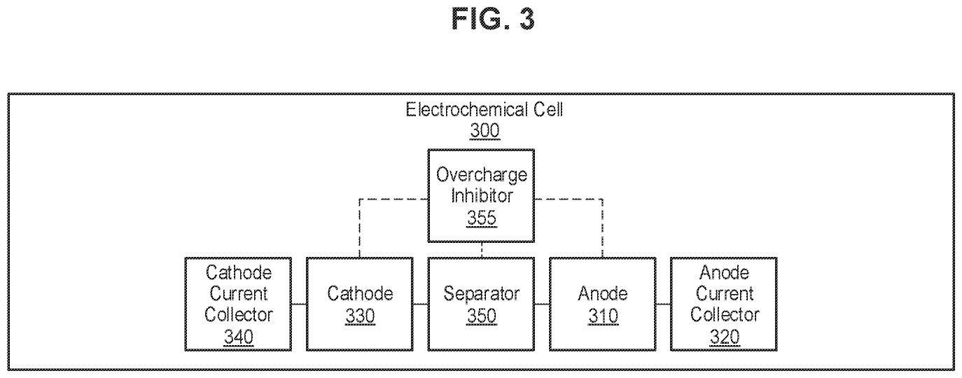

Embodiments described herein relate generally to electrochemical cells having overcharge inhibitors, and more specifically to systems and methods of providing overcharge protection in electrochemical cells by utilizing properties inherent to battery materials. FIG. 3 is a schematic illustration of an electrochemical cell 300, according to an embodiment. The electrochemical cell 300 includes an anode 310 disposed on an anode current collector 320, a cathode 330 disposed on a cathode current collector 340, and a separator 350 disposed between the anode 310 and the cathode 330. The electrochemical cell 300 further includes an overcharge inhibitor 355 disposed in the anode 310, in the cathode 330, in both the anode 310 and the cathode 330, in the separator 350, on a side of the separator 350 adjacent to the anode 310, on a side of the separator 350 adjacent to the cathode 330, or any combination thereof. In some embodiments, the overcharge inhibitor 355 can be disposed at an interface between the anode 310 and the anode current collector 320. In some embodiments, the overcharge inhibitor 355 can be disposed at an interface between the anode 310 and the separator 350. In some embodiments, the overcharge inhibitor 355 can be disposed at an interface between the cathode 330 and the cathode current collector 340. In some embodiments, the overcharge inhibitor 355 can be disposed at an interface between the cathode 330 and the separator 350. The overcharge inhibitor 355 is configured to prevent charge transfer via a charge transfer prevention mechanism when a triggering condition is met in the electrochemical cell 300.

In some embodiments, the anode 310 and/or the cathode 330 can be a semi-solid electrode. In comparison to conventional electrodes, semi-solid electrodes can be made (i) thicker (e.g., greater than about 250 μm—up to about 2,000 μm or even greater) due to the reduced tortuosity and higher electronic conductivity of semi-solid electrodes, (ii) with higher loadings of active materials, (iii) with a simplified manufacturing process utilizing less equipment, and (iv) can be operated between a wide range of C-rates while maintaining a substantial portion of their theoretical charge capacity. These relatively thick semi-solid electrodes decrease the volume, mass and cost contributions of inactive components with respect to active components, thereby enhancing the commercial appeal of batteries made with the semi-solid electrodes. In some embodiments, the semi-solid electrodes described herein, are binderless and/or do not use binders that are used in conventional battery manufacturing. Instead, the volume of the electrode normally occupied by binders in conventional electrodes, is now occupied, by: 1) electrolyte, which has the effect of decreasing tortuosity and increasing the total salt available for ion diffusion, thereby countering the salt depletion effects typical of thick conventional electrodes when used at high rate, 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes.

Since the semi-solid electrodes described herein can be made substantially thicker than conventional electrodes, the ratio of active materials (i.e., the semi-solid cathode and/or anode) to inactive materials (i.e. the current collector and separator) can be much higher in a battery formed from electrochemical cell stacks that include semi-solid electrodes relative to a similar battery formed form electrochemical cell stacks that include conventional electrodes. This substantially increases the overall charge capacity and energy density of a battery that includes the semi-solid electrodes described herein. The use of semi-solid, binderless electrodes can also be beneficial in the incorporation of an overcharge protection mechanism, as generated gas can migrate to the electrode/current collector interface without binder particles inhibiting the movement of the gas within the electrode.

In some embodiments, the electrode materials described herein can be a flowable semi-solid or condensed liquid composition. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in a liquid electrolyte to produce a semi-solid electrode. Examples of electrochemical cells that include a semi-solid and/or binderless electrode material are described in U.S. Pat. No. 8,993,159 entitled, “Semi-solid Electrodes Having High Rate Capability,” registered Mar. 31, 2015 (“the '159 patent”), the disclosure of which is incorporated herein by reference in its entirety.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “about” and “approximately” generally mean plus or minus 10% of the value stated, e.g., about 250 μm would include 225 μm to 275 μm, about 1,000 μm would include 900 μm to 1,100 μm.

As used herein, the term “semi-solid” refers to a material that is a mixture of liquid and solid phases, for example, such as a particle suspension, a slurry, a colloidal suspension, an emulsion, a gel, or a micelle.

As used herein, the term “conventional separator” means an ion permeable membrane, film, or layer that provides electrical isolation between an anode and a cathode, while allowing charge-carrying ions to pass therethrough. Conventional separators do not provide chemical and/or fluidic isolation of the anode and cathode.

Typical current collectors for lithium cells include copper, aluminum, or titanium for the negative current collector and aluminum for the positive current collector, in the form of sheets or mesh, or any combination thereof. Current collector materials can be selected to be stable at the operating potentials of the positive and negative electrodes of an electrochemical cell 300. For example, in non-aqueous lithium systems, the cathode current collector 340 can include aluminum, or aluminum coated with conductive material that does not electrochemically dissolve at operating potentials of 2.5-5.0V with respect to Li/Li⁺. Such materials include platinum, gold, nickel, conductive metal oxides such as vanadium oxide, and carbon. The anode current collector 320 can include copper or other metals that do not form alloys or intermetallic compounds with lithium, carbon, and/or coatings comprising such materials disposed on another conductor.

As described above, the overcharge inhibitor 355 is configured and/or formulated to prevent charge transfer in the electrochemical cell 300 when a certain condition (i.e., the triggering condition) is met. In some embodiments, the triggering condition that activates the overcharge inhibitor 355 can be a predetermined potential difference value between the anode 310 and the cathode 330 (i.e., cell voltage). During charging of the electrochemical cell 300, heat is generated in the electrochemical cell 300. Overcharging can lead to excessive heat generation, thereby raising the temperature in the electrochemical cell 300 until the anode 310 and/or the cathode 330 reaches or exceeds a predetermined temperature (i.e., the triggering condition). In some embodiments, the triggering condition can be a combination of cell voltage and temperature of the electrochemical cell 300. In some embodiments, an oxidation reaction can trigger the overcharge inhibitor 355. In some embodiments, a reduction reaction can trigger the overcharge inhibitor 355.

The overcharge inhibitor 355 can prevent charge transfer via one or more charge transfer prevention mechanisms. In some embodiments, the overcharge inhibitor 355 can be a compound or a plurality of compounds combined with the other electrode materials (e.g., the active materials, conductive additives, electrolyte, etc.) such that the overcharge inhibitor 355 generates a gas when the triggering condition is met. The generated gas can migrate to and collect near an interface between the electrode and the current collector (i.e., the interface between the cathode 330 and the cathode current collector 340 and/or the interface between the anode 310 and the anode current collector 320) to limit or substantially restrict electrical contact between the electrode and the current collector. In some embodiments, the generated gas can migrate to and collect near an interface between the electrode and the separator 350 (i.e., the interface between the anode 310 and the separator 350 and/or the interface between the cathode 330 and the separator 350). In some embodiments, the use of the overcharge inhibitor 355 in the binderless, semi-solid electrode material described herein can provide a strategic advantage because the generated gas is able to move freely toward the interface between the electrode and the current collector to interrupt the electrical connection between the electrode and the electrode current collector. In other words, the lack a binder results in less tortuosity for the generated gas to move through the electrode. In addition, a vertical orientation of the electrochemical cell 300 can be a strategic advantage in the migration of gas to the interface between the electrode and the current collector due to the effect of gravity and the density of the generated gas being lower than that of the other materials in the electrode. The immiscible gases can migrate upward with respect to the slurry materials within the electrode. If the current collector is located above the electrode, the immiscible gases can settle in the interface between the electrode and the current collector, thereby interrupting electrical contact between the electrode and the current collector.

In some embodiments, when the cell voltage approaches a predetermined cutoff voltage, the compound or plurality of compounds that make up the overcharge inhibitor 355 can be subject to one or more oxidation reactions in the electrode. The oxidation reactions can generate gases that migrate to the interface between the electrode and the current collector. The oxidation reactions can begin when the cell voltage reaches an initial oxidation voltage. At the initial oxidation voltage, gas bubbles begin to form in the electrode. In some embodiments, the gas generated at the initial oxidation voltage is not sufficient to inhibit electrical contact between the electrode and the current collector. In other words, at the initial oxidation voltage, the cell voltage has not yet reached the cutoff voltage and the electrochemical cell 300 can continue charging. As the cell voltage continues to increase to values greater than the initial oxidation voltage, more gas is generated. At a sufficient voltage, enough gas is generated to inhibit electrical contact between the electrode and the current collector, as the cutoff voltage has been reached. In some embodiments, the cutoff voltage can be greater than the initial oxidation voltage by about 0.1 V, about 0.2 V, about 0.3 V, about 0.4 V, about 0.5 V, about 0.6 V, about 0.7 V, about 0.8 V, about 0.9 V, about 1 V, about 1.1 V, about 1.2 V, about 1.3 V, about 1.4 V, about 1.5 V, about 1.6 V, about 1.7 V, about 1.8 V, about 1.9 V, or about 2.0 V, inclusive of all values and ranges therebetween.

In some embodiments, when the temperature of the electrochemical cell 300 approaches a predetermined cutoff temperature, the compound or plurality of compounds that make up the overcharge inhibitor 355 can be subject to one or more oxidation reactions in the electrode. The oxidation reactions can generate gases that migrate to the interface between the electrode and the current collector. The oxidation reactions can begin when the cell temperature reaches an initial oxidation temperature. At the initial oxidation temperature, gas bubbles begin to form in the electrode. In some embodiments, the gas generated at the initial oxidation temperature is not sufficient to inhibit electrical contact between the electrode and the current collector. In other words, at the initial oxidation temperature, the temperature of the electrochemical cell 300 has not yet reached the cutoff temperature and the electrochemical cell 300 can continue charging. As the cell temperature continues to increase to values greater than the initial oxidation temperature, more gas is generated. At a sufficient temperature, enough gas is generated to inhibit electrical contact between the electrode and the current collector, as the cutoff temperature has been reached. In some embodiments, the cutoff temperature can be greater than the initial oxidation temperature about 5° C., about 10° C., about 15° C., about 20° C., about 25° C., about 30° C., about 35° C., about 40° C., about 45° C., about 50° C., about 55° C., about 60° C., about 65° C., or about 70° C., inclusive of all values and ranges therebetween.

In some embodiments, the overcharge inhibitor 355 can be a chemical or a plurality of chemicals that oxidize at a prescribed temperature range. Similar to the chemicals triggered by a specific cell voltage, these generated gases can migrate to the interface between the electrode and the current collector. This can inhibit further charging and limit the temperature increase of the electrochemical cell 300. In some embodiments, the overcharge inhibitor 355 can limit the temperature of the electrochemical cell 300 to less than about 80° C., less than about 75° C., less than about 70° C., less than about 65° C., less than about 60° C., less than about 55° C., less than about 50° C., less than about 45° C., less than about 40° C., less than about 35° C., less than about 30° C., or less than about 25° C. In some embodiments, the overcharge inhibitor 355 can limit the difference between the temperature of the electrochemical cell 300 and the ambient temperature to less than about 50° C., less than about 45° C., less than about 40° C., less than about 35° C., less than about 30° C., less than about 25° C., less than about 20° C., less than about 15° C., less than about 10° C., less than about 9° C., less than about 8° C., less than about 7° C., less than about 6° C., or less than about 5° C.

In some embodiments, the overcharge inhibitor 355 can include a plurality of particles suspended in the cathode 330 and/or anode 310 that absorb liquid electrolyte and expand in the cathode 330 and/or anode 310 when the triggering condition is met. In some embodiments, the expanded particles can grow to a size such that they push on the other electrode materials and inhibit or fully interrupt the flow of ions in the electrode or electrodes. In some embodiments, the expanded particles can limit ion diffusion within the electrode. In some embodiments, the expanded particles can limit ion diffusion and/or electron movement at an interface between the anode 310 and the separator 350. In some embodiments, the expanded particles can limit ion diffusion and/or electron movement at an interface between the cathode 330 and the separator 350. The inhibition of ion flow and/or diffusion can inhibit or fully interrupt further charging of the electrochemical cell 300. In some embodiments, as described above with reference to gas generation, an initial oxidation voltage and/or temperature in the electrochemical cell 300 can be the triggering condition that causes the particles to absorb liquid electrolyte and expand. In some embodiments, the expanded particles can trigger oxidation and/or heat generation in the electrochemical cell 300, thereby providing the aforementioned triggers that can further activate the overcharge inhibitor 355. In some embodiments, the particles can be mixed in with the electrode materials. In some embodiments, the particles can be disposed near the separator 350. In some embodiments, the particles can be disposed on the surface of the separator 350. In some embodiments, the particles can be disposed on a surface of the separator 350 adjacent to the anode 310. In some embodiments, the particles can be disposed on a surface of the separator adjacent to the cathode 330. In some embodiments, the particles can be disposed in the separator 350 (i.e., in pores in the separator 350).

In some embodiments, the electrochemical cell 300 can be disposed in a pouch (not shown). Since the overcharge inhibitor 355 can be implemented without the use of external wiring or circuitry, the potential for leaks in the pouch is lower when compared to an external overcharge inhibitor. In some embodiments, the electrochemical cell 300 can be a single electrochemical cell disposed in a pouch, such that the electrochemical cell 300 is electrically isolated from nearby electrochemical cells. Electric isolation of the electrochemical cell 300 and nearby electrochemical cells can help localize conditions that trigger the overcharge inhibitor 355 (e.g., temperature increase) to a single electrochemical cell, rather than propagating the conditions that trigger the overcharge inhibitor 355 to multiple electrochemical cells.

In some embodiments, the overcharge inhibitor 355 can include any combination of the aforementioned methods and mechanisms. For example, the overcharge inhibitor 355 can include particles that absorb liquid electrolyte at a predetermined temperature as well as solutes in the electrode that generate gas at a predetermined temperature. In some embodiments, the overcharge inhibitor 355 can be in the cathode 330. In some embodiments, the overcharge inhibitor 355 can be in the anode 310. In some embodiments, the overcharge inhibitor can be in both the anode 310 and the cathode 330.

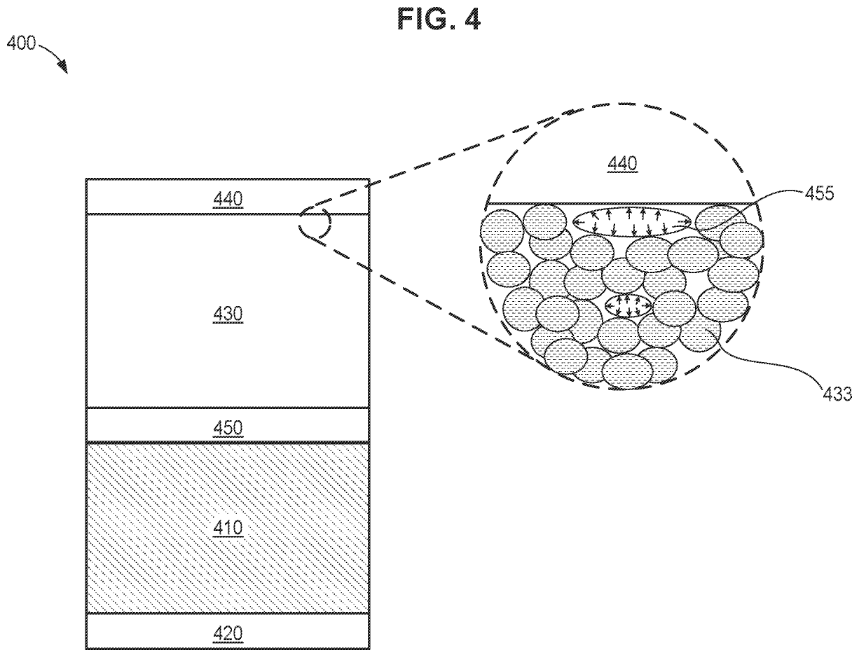

FIG. 4 is a schematic illustration of an electrochemical cell 400, according to an embodiment. The electrochemical cell 400 includes an anode 410 disposed on an anode current collector 420, a cathode 430 including cathode active material 433 disposed on a cathode current collector 440, and a separator 450 disposed between the anode 410 and the cathode 430. As shown, the electrochemical cell 400 further includes an overcharge inhibitor 455 disposed in the cathode 430, however, the overcharge inhibitor 455 can alternatively be disposed in the anode 410, or in both the anode 410 and cathode 430. In some embodiments, the overcharge inhibitor 455 can be disposed in the separator 450. In some embodiments, the overcharge inhibitor 455 can be disposed at an interface between the separator 450 and the anode 410. In some embodiments, the overcharge inhibitor 455 can be disposed at an interface between the separator 450 and the cathode 430. The overcharge inhibitor 455 includes one or more compounds that generate gas when a triggering condition is met in the electrochemical cell 400. As described above with reference to FIG. 3, the triggering condition can be a predetermined temperature in the electrochemical cell 400 and/or a predetermined voltage difference between the anode 410 and the cathode 430 (i.e., cell voltage). In some embodiments, the predetermined cell voltage that triggers the overcharge inhibitor 455 can be dependent on the battery chemistry used in the electrochemical cell 400. The compound or plurality of compounds used as the overcharge inhibitor 455 can be selected based on the potential, at which the compound or compounds oxidize. In some embodiments, the overcharge inhibitor 455 can undergo an oxidation reaction on a surface of the electrode to generate gas bubbles. The gas bubbles can migrate to the interface between the electrode and current collector, thereby breaking the electronic connection between the electrode and the current collector.

In some embodiments, the overcharge inhibitor 455 can generate gas and inhibit the electronic connection between the electrode and current collector when the electrochemical cell 400 or a portion thereof reaches or exceeds a temperature of about 25° C., about 30° C., about 35° C., about 40° C., about 45° C., about 50° C., about 55° C., about 60° C., about 65° C., about 70° C., about 75° C., about 80° C., about 85° C., about 90° C., about 95° C., or about 100° C., inclusive of all values and ranges therebetween.

In some embodiments, the overcharge inhibitor 455 can generate gas and inhibit the electronic connection between the separator 450 when the electrochemical cell 400 or a portion thereof reaches or exceeds a temperature of about 25° C., about 30° C., about 35° C., about 40° C., about 45° C., about 50° C., about 55° C., about 60° C., about 65° C., about 70° C., about 75° C., about 80° C., about 85° C., about 90° C., about 95° C., or about 100° C., inclusive of all values and ranges therebetween.

In some embodiments, the overcharge inhibitor 455 can limit cell voltage, such that the cell voltage does not exceed about 12 V, about 11 V, about 10 V, about 9 V, about 8 V, about 7 V, about 6 V, about 5 V, about 4.9 V, about 4.8 V, about 4.7 V, about 4.6 V, about 4.5 V, about 4.4 V, about 4.3 V, about 4.2 V, about 4.1 V, about 4 V, about 3.9 V, about 3.8 V, about 3.7 V, about 3.6 V, about 3.5 V, about 3.4 V, about 3.3 V, about 3.2 V, about 3.1 V, about 3 V, about 2.9 V, about 2.8 V, about 2.7 V, about 2.6 V, about 2.5 V, about 2 V, about 1.5 V, or about 1 V, inclusive of all values and ranges therebetween. In some embodiments, the compound or compounds used as the overcharge inhibitor 455 can include cyclohexyl benzene, biphenyl, p-terphenyl, diphenyl ether, diethyl carbonate, ethyl methyl carbonate, thiophene, 3-chlorotiophene, furan, γ-butyrolactone, acetonitrile, ethylene glycol sulfite, tris(hexafluoroisopropyl) phosphate, and combinations thereof.

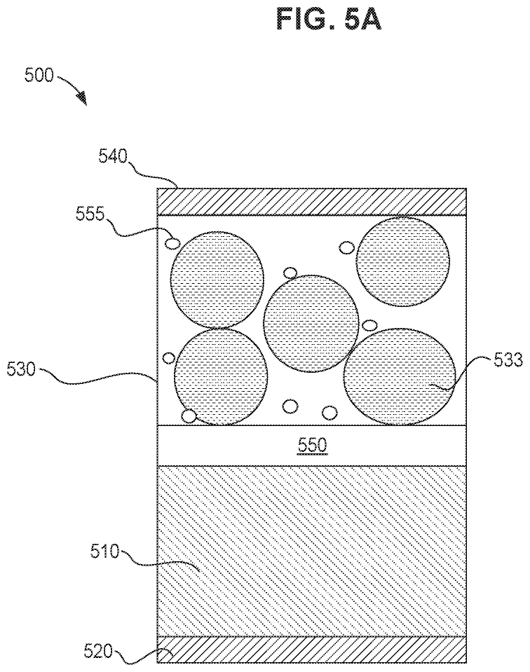

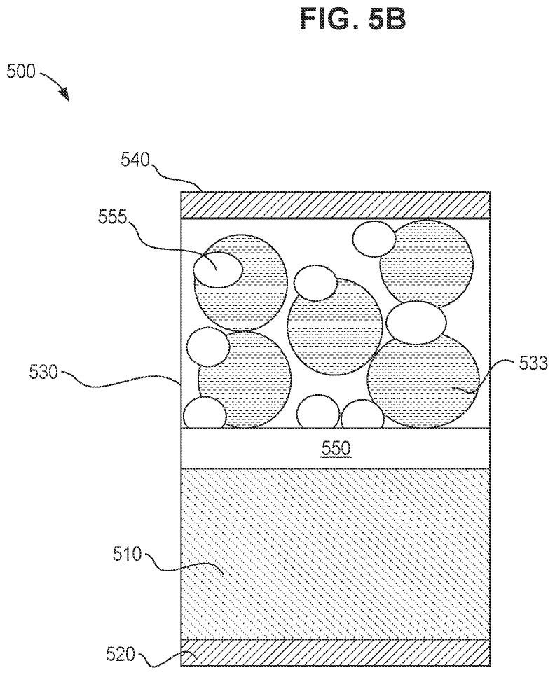

FIGS. 5A-5B are schematic illustrations of an electrochemical cell 500, according to an embodiment. The electrochemical cell 500 includes an anode 510 disposed on an anode current collector 520, a cathode 530 including cathode active material 533 disposed on a cathode current collector 540, and a separator 550 disposed between the anode 510 and the cathode 530. As shown, electrochemical cell 500 further includes an overcharge inhibitor 555 disposed in the cathode 530. In some embodiments, the overcharge inhibitor 555 can alternatively be disposed in the anode 510, or in both the anode 510 and cathode 530. In some embodiments, the overcharge inhibitor 555 can be disposed in the separator 550. In some embodiments, the overcharge inhibitor 555 can be disposed at an interface between the separator 550 and the anode 510. In some embodiments, the overcharge inhibitor 555 can be disposed at an interface between the separator 550 and the cathode 530. The overcharge inhibitor 555 includes a plurality of particles that absorb liquid electrolyte and expand when a triggering condition is met in the electrochemical cell 500. These expanded particles (see FIG. 5B) can block ion diffusion flow paths within an electrode. As described above with reference to FIG. 3 and FIG. 4, the triggering condition can be a predetermined temperature in the electrochemical cell 500 and/or a predetermined voltage difference between the anode 510 and the cathode 530 (i.e., cell voltage). In some embodiments, heat generation in the electrochemical cell 500 can trigger the overcharge inhibitor 555. In some embodiments, the electrode that includes the overcharge inhibitor 555 includes a semi-solid electrode (i.e., a particle suspension, a slurry, a colloidal suspension, an emulsion, a gel, or a micelle). In some embodiments, the overcharge inhibitor 555 can absorb a portion of the liquid electrolyte of the semi-solid electrode when the electrochemical cell 500 or a portion thereof reaches or exceeds a predetermined temperature.

In some embodiments, the overcharge inhibitor 555 can include a material that generates heat at a predetermined voltage. In some embodiments, the overcharge inhibitor 555 can be embedded or encapsulated in a material that generates heat at a predetermined voltage. This generated heat can facilitate absorption of liquid electrolyte in the particles that make up the overcharge inhibitor 555, causing the particles to expand. In some embodiments, the overcharge inhibitor 555 can be disposed in the electrode material. In some embodiments, the overcharge inhibitor 555 can be near the separator 530. In some embodiments, the overcharge inhibitor 555 can be disposed on the surface of the separator 530.

In some embodiments, the overcharge inhibitor 555 can include particles that begin to expand at an initial expansion voltage. In some embodiments, the particles are not large enough at the initial expansion voltage to substantially stop the charging of the electrochemical cell 500. In other words, at the initial expansion voltage, the cell voltage has not yet reached a cutoff voltage and the electrochemical cell 500 can continue charging. In some embodiments, the cutoff voltage can be greater than the initial expansion voltage 0.1 V, about 0.2 V, about 0.3 V, about 0.4 V, about 0.5 V, about 0.6 V, about 0.7 V, about 0.8 V, about 0.9 V, about 1 V, about 1.1 V, about 1.2 V, about 1.3 V, about 1.4 V, about 1.5 V, about 1.6 V, about 1.7 V, about 1.8 V, about 1.9 V, or about 2.0 V, inclusive of all values and ranges therebetween.

In some embodiments, the overcharge inhibitor 555 can include particles that begin to expand at an initial expansion temperature. In some embodiments, the particles are not large enough at the initial expansion temperature to substantially stop the charging of the electrochemical cell 500. In other words, at the initial expansion temperature, the cell voltage has not yet reached a cutoff temperature and the electrochemical cell 500 can continue charging. In some embodiments, the cutoff temperature can be greater than the initial expansion temperature by about 5° C., about 10° C., about 15° C., about 20° C., about 25° C., about 30° C., about 35° C., about 40° C., about 45° C., about 50° C., about 55° C., about 60° C., about 65° C., or about 70° C., inclusive of all values and ranges therebetween.

In some embodiments, the overcharge inhibitor 555 can include particles that expand from a first volume at the initial expansion temperature to a second volume at the cutoff expansion temperature. In some embodiments, the second volume can be larger than the first volume by a factor of at least about 1.1, at least about 1.2, at least about 1.3, at least about 1.4, at least about 1.5, at least about 1.6, at least about 1.7, at least about 1.8, at least about 1.9, at least about 2, at least about 3, at least about 4, at least about 5, at least about 6, at least about 7, at least about 8, at least about 10, at least about 20, at least about 30, at least about 40, at least about 50, at least about 60, at least about 70, at least about 80, or at least about 90. In some embodiments, the second volume can be larger than the first volume by a factor of no more than about 100, no more than about 90, no more than about 80, no more than about 70, no more than about 60, no more than about 50, no more than about 40, no more than about 30, no more than about 20, no more than about 10, no more than about 9, no more than about 8, no more than about 7, no more than about 6, no more than about 5, no more than about 4, no more than about 3, no more than about 2, no more than about 1.9, no more than about 1.8, no more than about 1.7, no more than about 1.6, no more than about 1.5, no more than about 1.4, no more than about 1.3, or no more than about 1.2. Combinations of the above-referenced expansion factors are also possible (e.g., at least about 1.1 and no more than about 100 or at least about 2 and no more than about 4), inclusive of all values and ranges therebetween. In some embodiments, the second volume can be larger than the first volume by a factor of about 1.1, about 1.2, about 1.3, about 1.4, about 1.5, about 1.6, about 1.7, about 1.8, about 1.9, about 2, about 3, about 4, about 5, about 6, about 7, about 8, about 10, about 20, about 30, about 40, about 50, about 60, about 70, about 80, about 90, or about 100.

The use of semi-solid, binderless electrodes can also be beneficial in the incorporation of the overcharge inhibitor 555 into the electrochemical cell 500. In some embodiments, expanded particles included in the overcharge inhibitor 555 can push and move active materials within the electrode to disrupt electronic conductive paths within the electrode. This mechanism can function in a semi-solid binderless electrode architecture much more effectively than in conventional electrode architecture.

In some embodiments, the overcharge inhibitor 555 can absorb liquid electrolyte when the electrochemical cell 500 or a portion thereof reaches or exceeds a temperature of about 25° C., about 30° C., about 35° C., about 40° C., about 45° C., about 50° C., about 55° C., about 60° C., about 65° C., about 70° C., about 75° C., about 80° C., about 85° C., about 90° C., about 95° C., or about 100° C., inclusive of all values and ranges therebetween.

In some embodiments, the overcharge inhibitor 555 can limit cell voltage, such that the cell voltage does not exceed about 12 V, about 11 V, about 10 V, about 9 V, about 8 V, about 7 V, about 6 V, about 5 V, about 4.9 V, about 4.8 V, about 4.7 V, about 4.6V, about 4.5V, about 4.4 V, about 4.3 V, about 4.2 V, about 4.1 V, about 4 V, about 3.9 V, about 3.8 V, about 3.7 V, about 3.6 V, about 3.5 V, about 3.4 V, about 3.3 V, about 3.2 V, about 3.1 V, about 3 V, about 2.9 V, about 2.8 V, about 2.7 V, about 2.6 V, about 2.5 V, about 2 V, about 1.5 V, or about 1 V, inclusive of all values and ranges therebetween. In some embodiments, the compound or compounds used as the overcharge inhibitor 555 can include polyvinylidene fluoride, polyacrylonitrile, polyethylene oxide, polysiloxane, carboxymethyl cellulose, and combinations thereof.

In some embodiments, the overcharge inhibitor 455/555, as described above with reference to FIG. 4 and FIG. 5, can be disposed in a layer of carbon that coats the current collector, such that the overcharge inhibitor 455/555 produces gas at a predetermined cell voltage. This gas can push semi-solid electrode materials away from the current collector and interrupt electrical contact between the current collector and the electrode.

Some embodiments and/or methods described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of” or “exactly one of” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure.

Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. An electrochemical cell, comprising:
an anode disposed on an anode current collector;
a cathode disposed on a cathode current collector;
a separator disposed between the anode and the cathode; and
an overcharge inhibitor disposed in at least one of the anode and the cathode and configured to inhibit ion movement when a triggering condition is met.

2. The electrochemical cell of claim 1, wherein the overcharge inhibitor includes a compound disposed in the cathode, the compound configured to generate a gas when a temperature in the cathode is greater than or equal to a predetermined temperature value,
and wherein the gas inhibits electrical contact between the cathode and the cathode current collector.

3. The electrochemical cell of claim 2, wherein the compound includes at least one of cyclohexyl benzene, biphenyl, p-terphenyl, diphenyl ether, diethyl carbonate, ethyl methyl carbonate, thiophene, 3-chlorotiophene, furan, γ-butyrolactone, acetonitrile, and ethylene glycol sulfite.

4. The electrochemical cell of claim 1, wherein the overcharge inhibitor includes a plurality of particles disposed in the cathode, the plurality of particles configured to absorb a portion of an electrolyte solution and expand in the cathode and inhibit the flow path of ions within the cathode, when a temperature in the cathode is greater than or equal to a predetermined temperature value,
and wherein the plurality of particles inhibit electrical contact between the cathode and the cathode current collector.

5. The electrochemical cell of claim 4, wherein the plurality of particles include at least one of polyvinylidene fluoride, polyacrylonitrile, polyethylene oxide, polysiloxane, and carboxymethyl cellulose.

6. The electrochemical cell of claim 1, wherein the overcharge inhibitor includes a compound disposed in the cathode, the compound configured to generate a gas when a potential difference between the anode and the cathode is greater than or equal to a predetermined voltage value,
and wherein the gas inhibits electrical contact between the cathode and the cathode current collector.

7. The electrochemical cell of claim 6, wherein the compound includes at least one of cyclohexyl benzene, biphenyl, p-terphenyl, diphenyl ether, diethyl carbonate, ethyl methyl carbonate, thiophene, 3-chlorotiophene, furan, γ-butyrolactone, acetonitrile, and ethylene glycol sulfite.

8. The electrochemical cell of claim 1, wherein the overcharge inhibitor includes a plurality of particles disposed in the cathode, the plurality of particles configured to absorb a portion of an electrolyte solution and expand in the cathode and inhibit the flow path of ions within the cathode when a potential difference between the anode and the cathode is greater than or equal to a predetermined voltage value,
and wherein the plurality of particles inhibit electrical contact between the cathode and the cathode current collector.

9. The electrochemical cell of claim 1, wherein the overcharge inhibitor includes a compound disposed in the anode, the compound configured to generate a gas when a temperature in the anode is greater than or equal to a predetermined temperature value,
and wherein the gas inhibits electrical contact between the anode and the anode current collector.

10. The electrochemical cell of claim 9, wherein the compound includes at least one of cyclohexyl benzene, biphenyl, p-terphenyl, diphenyl ether, diethyl carbonate, ethyl methyl carbonate, thiophene, 3-chlorotiophene, furan, γ-butyrolactone, acetonitrile, and ethylene glycol sulfite.

11. The electrochemical cell of claim 1, wherein the overcharge inhibitor includes a plurality of particles disposed in the anode, the plurality of particles configured to absorb a portion of an electrolyte solution and expand in the anode and inhibit the flow path of ions within the cathode, when a temperature in the anode is greater than or equal to a predetermined temperature value,
and wherein the plurality of particles inhibit electrical contact between the anode and the anode current collector.

12. The electrochemical cell of claim 1, wherein the cathode is semi-solid.

13. An electrochemical cell, comprising:
a first electrode material disposed on a first current collector;
a second electrode material disposed on a second current collector; and
a separator disposed between the first electrode material and the second electrode material,
wherein the first electrode material is a semi-solid electrode material, the semi-solid electrode material including an overcharge inhibitor configured to block ion movement when a triggering condition is met.

14. The electrochemical cell of claim 13, wherein the overcharge inhibitor includes a compound disposed in the semi-solid electrode material, the compound configured to generate a gas when a temperature in the semi-solid electrode material is greater than or equal to a predetermined temperature value,
and wherein the gas inhibits electrical contact between the semi-solid electrode material and the first current collector or the second current collector.

15. The electrochemical cell of claim 14, wherein the compound includes at least one of cyclohexyl benzene, biphenyl, p-terphenyl, diphenyl ether, diethyl carbonate, ethyl methyl carbonate, thiophene, 3-chlorotiophene, furan, γ-butyrolactone, acetonitrile, and ethylene glycol sulfite.

16. The electrochemical cell of claim 13, wherein the overcharge inhibitor includes a plurality of particles disposed in the semi-solid electrode material, the plurality of particles configured to absorb a portion of an electrolyte solution and expand in the semi-solid electrode material and inhibit the flow path of ions within the semi-solid electrode material, when a temperature in the semi-solid electrode material is greater than or equal to a predetermined temperature value,
and wherein the plurality of particles inhibit electrical contact between the semi-solid electrode material and the first current collector or the second current collector.

17. The electrochemical cell of claim 16, wherein the plurality of particles include at least one of polyvinylidene fluoride, polyacrylonitrile, polyethylene oxide, polysiloxane, and carboxymethyl cellulose.

18. The electrochemical cell of claim 13, wherein the overcharge inhibitor includes a compound disposed in the semi-solid electrode material, the compound configured to generate a gas when a potential difference between the first electrode material and the second electrode material is greater than or equal to a predetermined voltage value,
and wherein the gas inhibits electrical contact between the semi-solid electrode material and the first current collector or the second current collector.

19. An electrochemical cell, comprising:
a first electrode disposed on a first current collector, the first electrode including an overcharge inhibitor;
a second electrode disposed on a second current collector; and
a separator disposed between the anode and the cathode,
wherein the overcharge inhibitor inhibits ion movement in the first electrode when a temperature in the first electrode exceeds a threshold temperature and/or when a voltage between the first electrode and the second electrode exceeds a threshold voltage.

20. The electrochemical cell of claim 13, wherein the overcharge inhibitor includes a compound configured to generate a gas when the temperature in the first electrode is greater than or equal to the threshold temperature and/or when the voltage between the first electrode and the second electrode exceeds the threshold voltage,
and wherein the gas inhibits electrical contact between the cathode and the cathode current collector.

21. The electrochemical cell of claim 20, wherein the compound includes at least one of cyclohexyl benzene, biphenyl, p-terphenyl, diphenyl ether, diethyl carbonate, ethyl methyl carbonate, thiophene, 3-chlorotiophene, furan, γ-butyrolactone, acetonitrile, and ethylene glycol sulfite.

22. The electrochemical cell of claim 13, wherein the overcharge inhibitor includes a plurality of particles disposed in the first electrode, the plurality of particles configured to absorb a portion of an electrolyte solution and expand in the first electrode and inhibit the flow path of ions within the first electrode when the temperature in the first electrode is greater than or equal to the threshold temperature and/or when the voltage between the first electrode and the second electrode exceeds the threshold voltage,
and wherein the plurality of particles inhibit electrical contact between the first electrode and the first current collector.

23. The electrochemical cell of claim 22, wherein the plurality of particles include at least one of polyvinylidene fluoride, polyacrylonitrile, polyethylene oxide, polysiloxane, and carboxymethyl cellulose.

24. The electrochemical cell of claim 19, wherein the first electrode is semi-solid.

25. An electrochemical cell, comprising:
an anode disposed on an anode current collector;
a cathode disposed on a cathode current collector;
a separator disposed between the anode and the cathode; and
an overcharge inhibitor configured to inhibit ion movement when a triggering condition is met,
wherein the overcharge inhibitor is disposed on the separator and/or in the separator.

26. The electrochemical cell of claim 25, wherein the overcharge inhibitor includes a compound disposed on a side of the separator adjacent to the cathode, the compound configured to generate a gas when a temperature on the side of the separator adjacent to the cathode is greater than or equal to a predetermined temperature value,
and wherein the gas inhibits electrical contact between the separator and the cathode.

27. The electrochemical cell of claim 26, wherein the compound includes at least one of cyclohexyl benzene, biphenyl, p-terphenyl, diphenyl ether, diethyl carbonate, ethyl methyl carbonate, thiophene, 3-chlorotiophene, furan, γ-butyrolactone, acetonitrile, and ethylene glycol sulfite.

28. The electrochemical cell of claim 25, wherein the overcharge inhibitor includes a plurality of particles disposed on a side of the separator adjacent to the cathode, the plurality of particles configured to absorb a portion of an electrolyte solution and expand at an interface between the separator and the cathode and inhibit the flow path of ions between the cathode and the separator, when a temperature on the side of the separator adjacent to the cathode is greater than or equal to a predetermined temperature value,
and wherein the plurality of particles inhibit electrical contact between the cathode and the separator.

29. The electrochemical cell of claim 28, wherein the plurality of particles include at least one of polyvinylidene fluoride, polyacrylonitrile, polyethylene oxide, polysiloxane, and carboxymethyl cellulose.

30. The electrochemical cell of claim 25, wherein the overcharge inhibitor includes a compound disposed on a side of the separator adjacent to the cathode, the compound configured to generate a gas when a potential difference between the anode and the cathode is greater than or equal to a predetermined voltage value,
and wherein the gas inhibits electrical contact between the separator and the cathode.

31. The electrochemical cell of claim 30, wherein the compound includes at least one of cyclohexyl benzene, biphenyl, p-terphenyl, diphenyl ether, diethyl carbonate, ethyl methyl carbonate, thiophene, 3-chlorotiophene, furan, γ-butyrolactone, acetonitrile, and ethylene glycol sulfite.

32. The electrochemical cell of claim 25, wherein the overcharge inhibitor includes a plurality of particles disposed on a side of the separator adjacent to the cathode, the plurality of particles configured to absorb a portion of an electrolyte solution and expand at an interface between the separator and the cathode and inhibit the flow path of ions between the cathode and the separator and inhibit the flow path of ions between the cathode and the separator, when a potential difference between the anode and the cathode is greater than or equal to a predetermined voltage value,
and wherein the plurality of particles inhibit electrical contact between the cathode and the separator.

33. The electrochemical cell of claim 25, wherein the overcharge inhibitor includes a compound disposed on a side of the separator adjacent to the anode, the compound configured to generate a gas when a temperature on the side of the separator adjacent to the anode is greater than or equal to a predetermined temperature value, and wherein the gas inhibits electrical contact between the separator and the anode.

34. The electrochemical cell of claim 33, wherein the compound includes at least one of cyclohexyl benzene, biphenyl, p-terphenyl, diphenyl ether, diethyl carbonate, ethyl methyl carbonate, thiophene, 3-chlorotiophene, furan, γ-butyrolactone, acetonitrile, and ethylene glycol sulfite.

35. The electrochemical cell of claim 25, wherein the overcharge inhibitor includes a plurality of particles disposed on a side of the separator adjacent to the anode, the plurality of particles configured to absorb a portion of an electrolyte solution and expand at an interface between the separator and the anode and inhibit the flow path of ions between the anode and the separator, when a temperature on the side of the separator adjacent to the anode is greater than or equal to a predetermined temperature value,
and wherein the plurality of particles inhibit electrical contact between the anode and the separator.

36. The electrochemical cell of claim 25, wherein the cathode is semi-solid.
